(19) United States
(12) Patent Application Publication
(10) Pub. No.: US 2007/0060162 A1
(43) Pub. Date: Mar. 15, 2007

(54) Methods and apparatus to perform transmission bandwidth detection in wireless local area networks

(76) Inventors: Ariton E. Xhafa, Plano, TX (US); Manish Airy, New Delhi (IN)

Correspondence Address: TEXAS INSTRUMENTS INCORPORATED, P O BOX 655474, M/S 3999, DALLAS, TX, 75265, US

(21) Appl. No.: 11/452,526

(22) Filed: Jun. 14, 2006

Related U.S. Application Data
(60) Provisional application No. 60/701,287, filed on Jul. 21, 2005.

(51) Int. Cl. H04Q 7/20

(52) U.S. Cl. 455/450

(57) ABSTRACT

Methods and apparatus to perform transmission bandwidth detection in wireless local area networks are disclosed. A disclosed example method comprises receiving a first plurality of samples representative of a first signal transmitted on a first wireless local area network (WLAN) channel, computing a first correlation of a first portion of the first plurality of samples with a second portion of the first plurality of samples, setting a receiver mode to a first bandwidth if the first correlation exceeds a threshold and setting the receiver mode to a second bandwidth if the first correlation is less than the threshold.

### RELATED APPLICATIONS

This patent claims priority from U.S. Provisional Application Ser. No. 60/701,287, entitled “Automatic detection of 20/40 MHz transmission for next generation WLAN devices” which was filed on Jul. 21, 2005. U.S. Provisional Application Ser. No. 60/701,287 is hereby incorporated by reference in its entirety.

### FIELD OF THE DISCLOSURE

This disclosure relates generally to wireless local area networks (WLANs) and, more particularly, to methods and apparatus to perform transmission bandwidth detection in WLANs.

### BACKGROUND

Wireless local area networks (WLANs) have evolved to become a popular networking technology of choice for residences, enterprises, commercial and/or retail locations (e.g., hotspots). An example WLAN is based on the Institute of Electrical and Electronics Engineers (IEEE) 802.11x family of standards. Today, the IEEE 802.11x family of standards collectively encompass a wide range of physical layer technologies, medium access controller (MAC) protocols and data frame formats. Additionally, newer standards may include features that are not necessarily compatible with existing devices that implement one or more earlier standards.

### BRIEF DESCRIPTION OF THE DRAWINGS

FIG. 1 is a diagram of an example wireless local area network (WLAN) with an access point and a plurality of wireless stations constructed in accordance with the teachings of the invention.

FIG. 2 illustrates an example manner of implementing an example access point and/or an example wireless station of FIG. 1.

FIG. 3 is an example physical layer control protocol (PLCP) frame.

FIG. 4 illustrates an example manner of implementing and utilizing the example bandwidth detector of FIG. 2.

FIG. 5 illustrates an example manner of implementing the example correlator of FIG. 4.

FIG. 6 illustrates an additional example manner of implementing and utilizing the example bandwidth detector of FIG. 2.

FIGS. 7 and 8 are flowcharts representative of example machine accessible instructions that may be executed to implement the example bandwidth detector of FIGS. 2, 4 and/or 6.

FIG. 9 is a schematic illustration of an example processor platform that may be used and/or programmed to execute the example machine accessible instructions illustrated in FIGS. 7 and/or 8 to implement the example bandwidth detector of FIGS. 2, 4 and/or 6.

### DETAILED DESCRIPTION

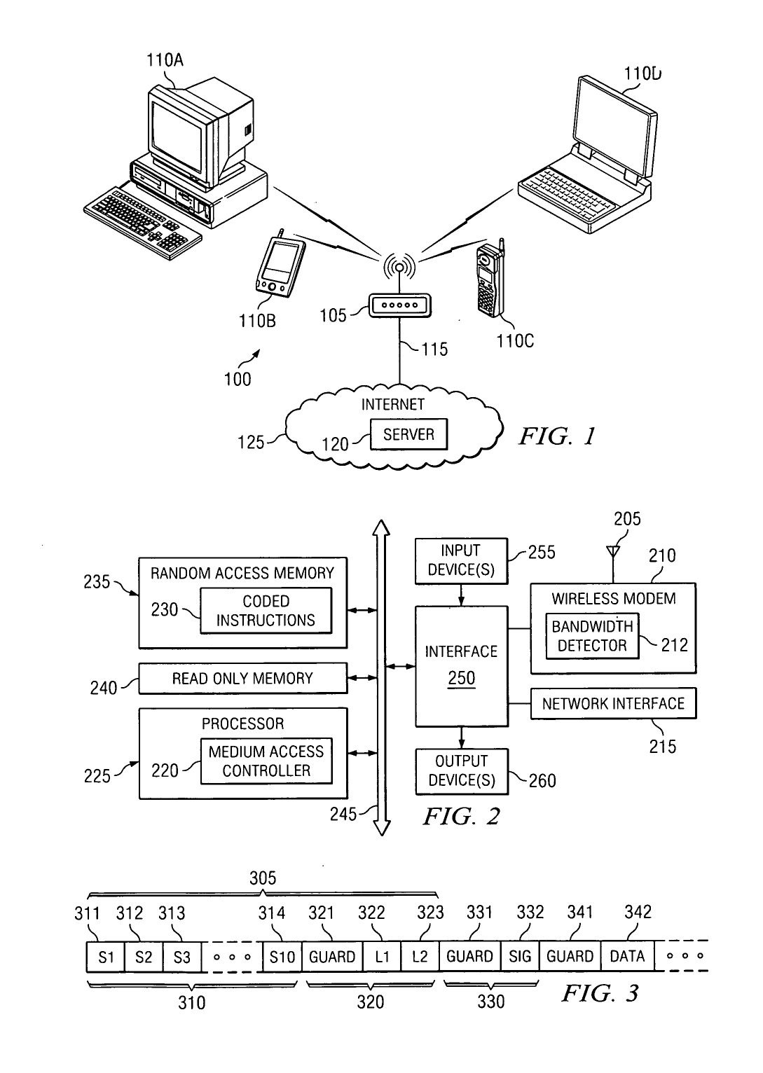

FIG. 1 is a schematic diagram of an example wireless local area network (WLAN) 100. To provide wireless data and/or communication services (e.g., telephone services, Internet services, data services, messaging services, instant messaging services, electronic mail (email) services, chat services, video services, audio services, gaming services, etc.), the example WLAN 100 of FIG. 1 includes an access point (AP) 105 and any of a variety of fixed-location and/or mobile wireless stations (STAs), four of which are respectively designated in FIG. 1 with reference numerals 110A, 110B, 110C and 110D. Example mobile STAs include a personal digital assistant (PDA) 110B, an MP3 player such as an iPod®, a wireless telephone 110C (e.g., a cellular phone, a voice over Internet Protocol (VoIP) phone, a smart phone, etc.), a laptop computer 110D with wireless communication capabilities, etc. Example fixed-location STAs include, for example, any variety of personal computer (PC) 110A with wireless communication capabilities.

The example AP 105 and/or each of the example STAs 110A-D of FIG. 1 are implemented in accordance with one or more past, present and/or future wired and/or wireless communication standards (e.g., one or more past, present and/or future standards from the IEEE 802.11x family of standards) and/or features from one or more of those standards. Moreover, the AP 105 and/or each of the STAs 110A-D may implement a similar and/or a different set and/or combination of the IEEE 802.11x standards as the AP 105 and/or any of the other STAs 110A-D. For example, the example laptop 110D and the example PDA 110B of the illustrated example support 20 million cycles per second (MHz) wireless signals and/or 40 MHz wireless signals (e.g., IEEE 802.11n) while the example PC 110A of the illustrated example supports only 20 MHz wireless signals (e.g., a standard pre-dating IEEE 802.11n). To facilitate compatibility and/or interoperability between older STAs 110A-D (e.g., a PC 110A that only supports 20 MHz signals, that is, a legacy device) and a new AP 105 and/or newer STAs (e.g., a laptop 110D or PDA 110B that support 20 MHz and/or 40 MHz signals, that is, dual mode devices), one or more of the example AP 105 and/or the example STAs 110A-D automatically detect and/or differentiate 20 MHz and 40 MHz WLAN transmission signals. In response to the detection of a 20 MHz or a 40 MHz signal, such STAs 110A-D may subsequently configure their receiver to support the detected signal bandwidth. For example, the AP 105 can a) detect a 20 MHz signal transmission and then switch into 20 MHZ operation and/or b) detect a 40 MHZ signal transmission and then switch into 40 MHz operation. In this fashion, the example AP 105 and/or the example STAs 110A-D can support and interoperate with 1) legacy devices that support only 20 MHz transmissions and/or 2) newer devices that support 40 MHz operation and/or dual-mode transmissions. Methods and apparatus to detect transmission signal bandwidths and/or utilize a detected transmission signal bandwidth are discussed below in connection with FIGS. 2-9.

In the example of FIG. 1, to allow the plurality of example STAs 110A-D to communicate with devices and/or servers located outside the example WLAN 100, the example AP 105 is communicatively coupled via any of a variety of communication paths 115 to, for example, any of a variety of servers 120 associated with public and/or private network(s) such as the Internet 125. The example server 120 may be used to provide, receive and/or deliver, for example, any variety of data, video, audio, telephone, gaming, Internet, messaging, electronic mail, etc. service. Additionally or alternatively, the example WLAN 100 of FIG. 1 may be communicatively coupled to any of a variety of public, private and/or enterprise communication network(s), computer(s), workstation(s) and/or server(s) to provide any of a variety of voice service(s), data service(s) and/or communication service(s).

While a single AP 105 is illustrated in the example of FIG. 1, persons of ordinary skill in the art will readily appreciate that the example WLAN 100 could include any of a variety of APs 105. For example, to provide wireless data and/or communication services over a site, location, building, geographic area and/or geographic region, a plurality of communicatively coupled APs 105 could be utilized. For example, a plurality of APs 105 could be arranged in a pattern and/or grid with abutting and/or overlapping coverage areas such that any of a variety of fixed-location STAs 110A-D and/or mobile STAs 110A-D located in, and/or moving through and/or within an area communicatively covered by one or more of the plurality of APs 105 can communicate with at least one of the APs 105.

While this disclosure refers to the example WLAN 100, the example AP 105 and/or the example STAs 110A-D of FIG. 1, the example WLAN 100 of FIG. 1 may be used to provide services to, from and/or between any alternative and/or additional wired and/or wireless communication devices (e.g., telephone devices, personal digital assistants (PDA), laptops, etc.). Additionally, although for purposes of explanation, this disclosure refers to the example WLAN 100, the example AP 105 and/or the example STAs 110A-D illustrated in FIG. 1, any additional and/or alternative variety and/or number of communication systems, communication devices and/or communication paths may be used to implement a WLAN and/or provide data and/or communication services. Moreover, while this disclosure references 20 MHz devices, 40 MHz devices and/or dual-mode 20/40 MHz devices, persons of ordinary skill in the art will appreciate that devices operating with any other bandwidth(s) may, additionally or alternatively, be employed.

Similarly, while for purposes of illustration, this disclosure references detecting and/or responding to transmission signal bandwidths for the example WLAN 100 of FIG. 1, persons of ordinary skill in the art will readily appreciate that the methods and apparatus disclosed herein may additionally or alternatively be applied to any type of wired and/or wireless communication system and/or network.

FIG. 2 illustrates an example manner of implementing any of the example AP 105 and/or the example STAs 110A-D of FIG. 1. For ease of discussion, the example device of FIG. 2 will be referred to as an AP/STA to make clear that the device may be either an AP 105 and/or a STA 110A-D. To support wireless communications with the example AP 105 and/or one or more of the example STAs 110A-D of the example WLAN 100 of FIG. 1, the example AP/STA of FIG. 2 includes any of a variety of radio frequency (RF) antennas 205 and any of a variety of physical-layer wireless modems 265 that supports 20 MHz and/or 40 MHz wireless signals, wireless protocols and/or wireless communications (e.g., according to IEEE 802.11n). The example RF antenna 205 and the example wireless modem 210 of FIG. 2 are able to receive, demodulate and decode WLAN signals transmitted to and/or within the example WLAN 100 of FIG. 1. Likewise, the wireless modem 210 and the RF antenna 205 are able to encode, modulate and transmit 20 MHz and/or 40 MHz WLAN transmissions from the example AP/STA to the example AP 105 and/or any or all of the example STAs 110A-D of the example WLAN 100 of FIG. 1. Thus, as commonly referred to in the industry, the example RF antenna 205 and the example wireless modem 210 collectively implement the “physical layer” (a.k.a., PHY) for the example AP/STA of FIG. 2.

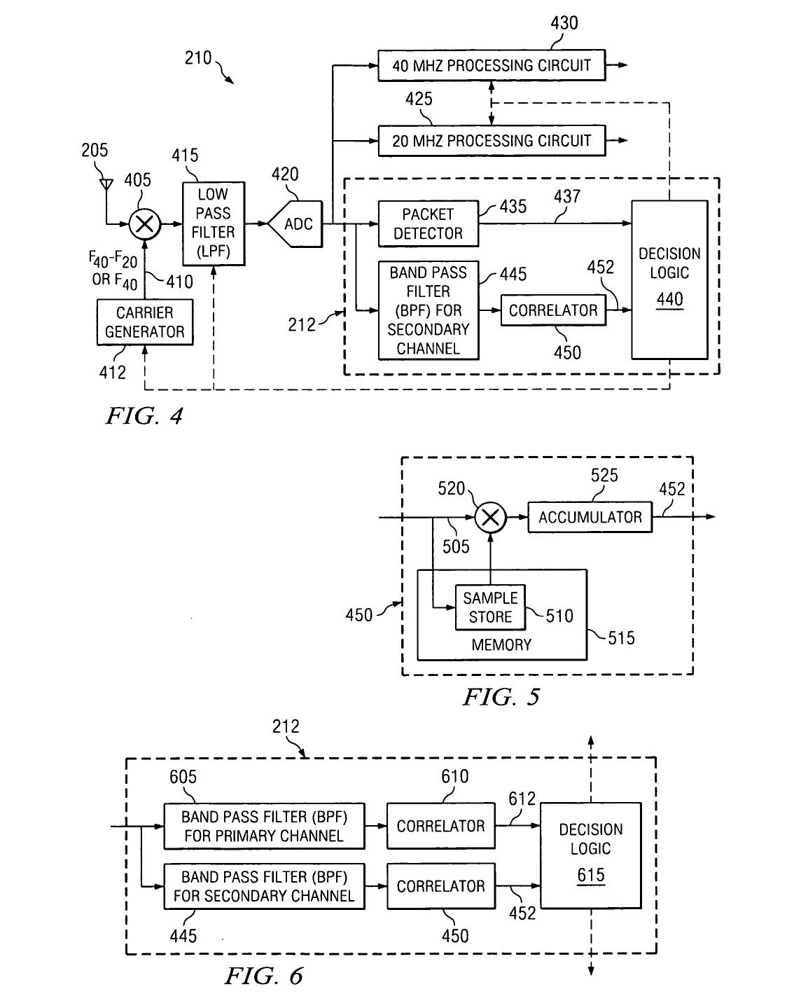

To detect bandwidth(s) of received wireless transmissions, the example wireless modem 210 of FIG. 2 includes a bandwidth detector 212. The example bandwidth detector 212 of FIG. 2 detects and/or discriminates between received 20 MHz and 40 MHz transmissions. In response to a transmission signal bandwidth detected by the example bandwidth detector 212, the example wireless modem 210 configures itself for operation using the detected signal bandwidth. Example implementations of the example bandwidth detector 212 and/or, more generally, the example wireless modem 210 are discussed below in connection with FIGS. 4-9.

To communicatively couple the example AP/STA of FIG. 2 to another device and/or network (e.g., a local area network (LAN), the Internet 125, etc.), the example AP/STA of FIG. 2 includes any of a variety of network interface 215. An example network interface 215 operates in accordance with any of the IEEE 802.3x family of standards.

To provide medium access functionality, the example AP/STA of FIG. 2 includes any of a variety medium access controllers (MACs) 220. To implement the example MAC 220 using one or more of any of a variety of software, firmware, processing thread(s) and/or subroutine(s), the example AP/STA of FIG. 2 includes a processor 225. The processor 225 may be one or more of any of a variety of processors such as, for example, a microprocessor, a microcontroller, a digital signal processor (DSP), an advanced reduced instruction set computing (RISC) machine (ARM) processor, etc. The example processor 225 of FIG. 2 executes coded instructions 230 which may be present in a main memory of the processor 225 (e.g., within a random-access memory (RAM) 235) and/or within an on-board memory of the processor 225. While in the illustrated example of FIG. 2, the example MAC 220 is implemented by executing one or more of a variety of software, firmware, processing thread(s) and/or subroutine(s) with the example processor 225, the example MAC 220 may be, additionally or alternatively, implemented using an application specific integrated circuit (ASIC), a programmable logic device (PLD), a field programmable logic device (FPLD), discrete logic, hardware, firmware, etc. Also, some or all of the example MAC 220 may be implemented manually or as combination(s) of any of the foregoing techniques, for example, the MAC 220 may be implemented by a combination of firmware, software and/or hardware. Example methods and apparatus to implement the example MAC 220 of FIG. 2 are described in U.S. patent application Ser. No. (Attorney Docket TI-60884), which is hereby incorporated by reference in its entirety.

The processor 225 is in communication with the main memory (including the RAM 235 and a read-only memory (ROM) 240) via a bus 245. The RAM 235 may be implemented by DRAM, SDRAM, and/or any other type of RAM device. The ROM 240 may be implemented by flash memory and/or any other desired type of memory device. Access to the memories 235 and 240 is typically controlled by a memory controller (not shown).

The example AP/STA of FIG. 2 also includes an interface circuit 250. The interface circuit 250 may implement one or more of a variety of interfaces, such as an external memory interface, serial port, general purpose input/output, etc. Additionally or alternatively, the interface circuit 250 may communicatively couple the example wireless modem 210 and/or the network interface 215 with the processor 225 and/or the example MAC 220.

In the example of FIG. 2, one or more input devices 255 and one or more output devices 260 are connected to the interface circuit 250. Example input devices 255 include a keyboard, touchpad, buttons and/or keypads, etc. Example output devices 260 include a display (e.g., a liquid crystal display (LCD)), a screen, a light emitting diode (LED), etc.

While an example AP/STA has been illustrated in FIG. 2, the elements, modules, logic, memory and/or devices illustrated in FIG. 2 may be combined, re-arranged, eliminated and/or implemented in any of a variety of ways. Further, the example interface 250, the example wireless modem 210, the example bandwidth detector 212, the example network interface 215, the example MAC 220 and/or, more generally, the example AP/STA may be implemented by hardware, software, firmware and/or any combination of hardware, software and/or firmware. Moreover, the AP/STA may include additional elements, modules, logic, memory and/or devices than those illustrated in FIG. 2 and/or may include more than one of any or all of the illustrated elements, modules and/or devices.

FIG. 3 illustrates an example physical layer control protocol (PLCP) preamble 305 of an example orthogonal frequency division multiplexing (OFDM) frame as defined in a standard such as, for example, the IEEE 802.11a, 802.11h and/or 802.11j standards. To facilitate start of frame detection, antenna selection, large scale timing synchronization and/or coarse carrier frequency offset estimation, the example PLCP preamble 305 of FIG. 3 includes a short training sequence 310 and a long training sequence 320.

As illustrated in FIG. 3, the example short training sequence 310 includes a plurality of transmitted short training symbols and/or sequences 311-314. In the illustrated example, there are ten (10) transmitted short training symbols and/or sequences 311-314 (six (6) of which are not shown in FIG. 3 and, they are not assigned unique reference numerals) and the ten transmitted short training symbols and/or sequences 311-314 are identical. Thus, the example short training sequence 310 includes ten (10) repetitions of the short training symbol and/or sequence 311. The example short training sequence short training symbols and/or sequences 311-314 of FIG. 3 are in accordance with, for example, the IEEE 802.11a, 802.11h, 802.11j and/or 802.11n standards. At a wireless transmitter, each of the short training symbols and/or sequences 311-314 have a duration of 0.8 microseconds and, thus, correspond to 16 digital transmit samples at a sampling rate of 20 MHz. While the example short training sequence 310 of FIG. 3 includes ten repetitions of a particular short training symbol and/or sequence, any of a variety of short training sequences 310 could, additionally or alternatively, be used.

To facilitate detection of the boundary between the short training sequence 310 and the long training sequence 320 and/or to protect reception of and/or fidelity of the long training sequence 320, the example long training sequence 320 of FIG. 3 includes a guard interval 321. Following the example guard interval 321, the example long training sequence 320 of FIG. 3 includes two OFDM symbols 322 and 323. In the example of FIG. 3, the guard interval 321 is created as a cyclic prefix of the OFDM symbol 322. The example OFDM symbols 322 and 323 of FIG. 3 are in accordance with, for example, the IEEE 802.11a, 802.11h, 802.11j and/or 802.11n standards. While the example long training sequence 320 of FIG. 3 includes two OFDM symbols, any of a variety of long training sequences 320 could, additionally or alternatively, be used.

To convey any of a variety of signal field information and/or data (e.g., data rate, etc.), the example OFDM frame of FIG. 3 includes a PLCP header 330 that includes a guard interval 331 and OFDM symbol(s) 332 that convey the signal field information and/or data. The example guard interval 331 of FIG. 3 is a cyclic prefix of the example OFDM symbol(s) 332.

To convey, for example, user data, the example OFDM frame of FIG. 3 includes at least a first OFDM data symbol 342 protected by a guard interval 341. As illustrated in FIG. 3, any number of additional guard intervals and/or OFDM data symbols may follow the first ODFM data symbol 342. In illustrated example of FIG. 3, guard intervals are cyclic prefixes of respective subsequent OFDM data symbols.

While an example OFDM preamble and frame start are illustrated in FIG. 3, persons of ordinary skill in the art will readily appreciate that any of variety of additional and/or alternative preambles and/or frames could be utilized. Additionally, while the following disclosure is made with reference to the example OFDM preamble of FIG. 3, the methods and apparatus discussed below in connection with FIGS. 4-9 could be used to detect transmission signal bandwidths for any of a variety of OFDM preambles and/or OFDM PHYs (e.g., as defined in IEEE 802.11a, 802.11h, 802.11j, 802.11n and/or any future developed standard). Moreover, the methods and apparatus discussed herein may be applied to other types of WLAN signals and/or PHYs such as, for example, frequency-hopping PHYs and/or signals (e.g., IEEE 802.11), direct sequence PHYs and/or signals (e.g., IEEE 802.11b), extended rate PHYs and/or signals (e.g., IEEE 802.11g), etc.

For 20 MHz transmissions, the example frame of FIG. 3 is transmitted on the primary channel. However, for 40 MHz transmissions the example frame of FIG. 3 is transmitted on both the primary and the secondary 20 MHz channels that collectively form a 40 MHz transmission. Thus, as discussed below in connection with FIG. 4, the example bandwidth detector 212 of FIG. 2 utilizes the short training sequence transmitted on the secondary channel to detect a 40 MHz transmission. Additionally or alternatively, the example bandwidth detector 212 can detect the short training sequence on both the primary and secondary channels to detect a 40 MHz transmission. Likewise, a 20 MHz transmission can be detected by detecting the short training sequence on only the primary channel. Further, while the frame of FIG. 3 can be utilized for distinguishing 20 MHz and 40 MHz transmissions, 20 MHz and 40 MHz transmissions can, additionally or alternatively, be distinguished based upon, for example, the particular short training symbols and/or sequences (e.g., the example short training symbol and/or sequence 311) used to create the short training sequence 310 and/or the long training sequence 315.

FIG. 4 illustrates an example manner of implementing and/or utilizing the example bandwidth detector 212 of FIG. 2 and/or, more generally, an example manner of implementing a portion of the example wireless modem 210 of FIG. 2 that is associated with the example bandwidth detector 212. To demodulate a signal received via the RF antenna 205, the example wireless modem 210 includes any of a variety of modulators 405. Using a carrier frequency signal 410, the example modulator 405 of FIG. 4 demodulates a received signal from a carrier frequency to a baseband and/or intermediate frequency. In the illustrated example of FIG. 4, the carrier frequency signal 410 has a frequency of F₄₀ or F₄₀-F₂₀, where F₄₀ and F₂₀ are the current active carrier (i.e., channel) frequencies for 40 MHz and 20 MHz WLAN signals, respectively.

To control, select and/or generate the carrier frequency signal 410, the example wireless modem 210 of FIG. 4 includes any of a variety carrier generators 412. The example carrier generator 412 of FIG. 4 controls, selects and/or generates the carrier frequency signal 410 in response to and/or as directed by the example bandwidth detector 212.

To extract a desired frequency portion of a received signal, the example wireless modem 210 of FIG. 4 includes any of a variety of low-pass filters (LPFs) 415. For example, if the carrier signal 410 has a frequency of F₄₀, an example LPF 415 having a bandwidth of 40 MHz can be used to extract and/or pass through both 20 MHz and 40 MHz signals to allow the example bandwidth detector 212 of FIG. 2 to detect both 20 MHz and 40 MHz transmissions. Alternatively, for reception of 20 MHz transmissions, the carrier signal 410 may be set to a frequency of F₄₀-F₂₀ and the example LPF 415 of FIG. 4 may be used to extract only the primary channel of a 20 MHz transmission. Depending upon the capabilities and/or configuration of the example wireless modem 210, a carrier signal 410 having a frequency of F₄₀ may be used for reception of 40 MHz and 20 MHz transmissions. In response to and/or as directed by the example bandwidth detector 212, the example LPF 415 of FIG. 4 may be bypassed, reconfigured and/or disabled to support detection and/or reception of 20 MHz and 40 MHz transmissions.

To convert analog signals into digital samples that may be digitally processed by the example bandwidth detector 212, the example wireless modem 210 of FIG. 4 includes any of a variety of analog-to-digital converters (ADCs) 420. The example ADC 420 of FIG. 4 operates at a frequency of at least twice the bandwidth of a desired receive signal bandwidth to reduce effects due to, for example, aliasing. An example sampling rate for the example ADC 420 is 80 MHz.

To process and/or decode received 20 MHz transmissions, the example wireless modem 210 of FIG. 4 includes any of a variety of 20 MHz processing circuits 425. Likewise, the receive and/or decode 40 MHz transmissions, the example wireless modem 210 of FIG. 4 includes any of a variety of 40 MHZ processing circuits 430. Among other things, the example processing circuits 425, 430 process a received signal by, for example, performing constellation decoding, error correction decoding, carrier frequency and/or timing adjustments, etc. Example OFDM-based processing circuits 425, 430 perform an inverse discrete Fourier transform (DFT) and constellation decoding to, for example, extract a user data/bit stream from a received OFDM signal.

If as discussed above, the carrier signal 410 has a frequency of F₄₀ and the example LPF 415 has a bandwidth of 40 MHz, both 20 MHz and 40 MHz transmissions can be received and/or processed by the example bandwidth detector 212 of FIG. 4. Further, for 20 MHz transmissions, both the primary and secondary channels can be received and/or processed by the example bandwidth detector 212 of FIG. 4.

To detect the start of a 20 MHz PLCP frame (i.e., a packet) of a 20 MHz transmission, the example bandwidth detector 212 of FIG. 4 includes a packet detector 435. Using any of a variety of algorithm(s), method(s) and/or technique(s), the example packet detector 435 utilizes a frame preamble (e.g., the example preamble 305 of FIG. 3) to detect the start of a 20 MHz packet (i.e., frame) on the primary channel. An example packet detector 435 detects the start of a packet by performing a correlation process as discussed below in connection with an example correlator 450. As illustrated in FIG. 4, an indication 437 of whether or not a packet is detected is provided by the example packet detector 435 to decision logic 440.

To detect the start of a frame on the secondary channel of a 40 MHz transmission, the example bandwidth detector 212 of FIG. 4 includes a band-pass filter (BPF) 445 and the correlator 450. The example BPF 445 of FIG. 4 has a center frequency and/or bandwidth configured and/or adjustable to substantially pass the secondary channel of a 40 MHz transmission while sufficiently attenuating other signals that may be received by the antenna 205 (e.g., the primary channel of a 40 MHz transmission, a 20 MHz transmission, out-of-band noise, etc.).

Recognizing that the start of a frame includes a short training sequence (e.g., the example short training sequence 310 of FIG. 3) that includes repetitions of short training symbol and/or sequence, the example correlator 450 of FIG. 4 detects the start of the frame by performing a correlation. The example correlator 450 correlates a current set of samples (e.g., for a current short training symbol and/or sequence) with previous sets of samples (e.g., for previous short training symbols and/or sequences). Previous sets of samples are captured and stored by the example correlator 405. In the illustrated example, the number of samples in each set depends on the time duration of symbols and/or sequences of the short training sequence and, thus, depends upon the sampling frequency (i.e., conversion frequency) of the example ADC 420. In the example of FIG. 4, the ADC 420 operates at a frequency of 80 MHz and the length of each set is 64 samples. The example ADC 420 of FIG. 4 may be configured to operate at a different frequency from that of a digital-to-analog converter (e.g., 20 MHz) used by a wireless transmitter to transmit the short training sequence and, thus, the number of samples in each set (e.g., 64) may be different from the number of sample used to represent each repetition of the short training sequence at the wireless transmitter (e.g., 16). That is, the ADC 420 may oversample and/or upsample the received short training sequence.

In the illustrated example, the example correlator 450 only utilizes the sign of each sample (e.g., + or −) when performing correlations. However, persons of ordinary skill in the art will readily appreciate that any number of bits of each sample could, additionally or alternatively, be used when performing correlations. As illustrated, an output of the correlation 452 is provided by the example correlator 450 to the decision logic 440. An example implementation of the example correlator 450 is discussed below in connection with FIG. 5.

To decide if a received transmission is 20 MHz or 40 MHz, the example bandwidth detector 212 of FIG. 4 includes decision logic 440. The example decision logic 440 of FIG. 4 makes a bandwidth determination based upon a) a packet detection indication 437 provided by the example packet detector 435 and/or b) a correlation output value 452 provided by the example correlator 452. If the packet detection indication 437 is negative, the example decision logic 440 determines that neither a 20 MHz nor a 40 MHz transmission was detected. If the packet detection indication 437 is positive, then the example decision logic 440 of FIG. 4 determines that either a 20 MHz or a 40 MHz transmission was detected and/or started. If the absolute value of the correlation output value 452 exceeds a threshold, the example decision logic 440 of FIG. 4 determines that a 40 MHz transmission was detected and/or has started. In the example of FIG. 4, the threshold is chosen sufficiently high to reduce the likelihood of false detection while not being so high as cause miss detections of a 40 MHz transmission. For example, the threshold may be set at 70 percent of a maximum possible correlation output value (e.g., 45 which is 70 percent of 64). If the absolute value of the correlation output value 452 does not exceed the threshold, the example decision logic 440 determines that a 20 MHz transmission was detected and/or has started.

Persons of ordinary skill in the art will readily appreciate that correlation sums may be provided more and/or less often than at short training symbol and/or sequence boundaries. Moreover, any number of method(s), technique(s) and/or algorithm(s) may be used to compute the correlation sums. For example, the correlation process may utilize past intermediate results to facilitate accelerate computation of correlation sums. Further, rather than using a single correlation sum that represents the correlation of a current set of samples with all the samples of previous sets of samples (i.e., a cumulative accumulation sum), multiple correlation sums that represents the correlation of the current set of samples with each of the previous sets of samples could be used. For example, instead of comparing a single cumulative accumulation sum with a threshold, each of the multiple correlation sums could be compared to the threshold and be required to have an absolute value that exceeds the threshold in order to determine and/or detect 20 MHz and 40 MHz transmissions. For ease of discussion, the following discussion utilizes a single cumulative accumulation sum at short training symbol and/or sequence boundaries. However, any of a number and/or variety of accumulation sums may be used at any of a variety of time instants to detect and/or determine 20 MHz and 40 MHz transmissions.

As illustrated in FIG. 4, if the example decision logic 440 determines that a 20 MHz transmission was detected and/or has started, the example decision logic 440 may configure the example carrier generator 412, the example LPF 415 and/or the example processing circuits 425, 430 for receiving and/or processing a 20 MHz transmission. Likewise, if the example decision logic 440 determines that a 40 MHz transmission was detected and/or has started, the example decision logic 440 may configure the example carrier generator 412, the example LPF 415 and/or the example processing circuits 425, 430 for receiving and/or processing of a 40 MHz transmission. Since the example WLAN 100 of FIG. 1 utilizes packet based transmissions, at the end of detected frame, the example wireless modem 210 may be again configured to detect and distinguish 20 MHz and 40 MHz transmissions. Alternatively, if the detected frame is not addressed to the AP/STA to which the wireless modem 210 is associated, the example wireless modem 210 may be immediately configured to start detection and distinguishing of 20 MHz and 40 MHz transmissions before the current frame has ended. Which of the example carrier generator 412, the example LPF 415 and/or the example processing circuits 425, 430 need to be configured based upon the mode of the wireless modem 210 (e.g., 20 MHz reception, 40 MHz reception, 20/40 MHz detection, etc.) depends upon an implementation and/or capabilities of the wireless modem 210.

FIG. 5 illustrates an example manner of implementing the example correlator 450 of FIG. 4. To store or otherwise make available previously received and/or filtered samples 505, the example correlator 450 of FIG. 5 includes a sample store 510. Received samples 505 are stored in the sample store 510 using any of a variety of data structure(s), data table(s), data array(s), etc. The example sample store 510 is stored in, for example, any of a variety of memory(-ies) 515. As the example correlator 450 of FIG. 5 operates samples 505 are continuously being received and used to form sets of samples 510. When a new set of samples 510 is completed an oldest set of samples is discarded. In this fashion, the sample store 510 is updated and, thus, contains a beneficial number of recent sets of samples 510.

To multiply a current set of samples 505 with one or more previous set(s) of samples stored in the example sample store 510, the example correlator 450 of FIG. 5 includes any of a variety of multipliers 520. The example multiplier 520 of FIG. 5 multiplies only the sign bits of the samples and, thus, forms an output having only a sign bit. However, persons of ordinary skill in the art will readily appreciate that the multiplier 520 could utilize any bit-width multiplier and/or have any output bit-width. Moreover, while a single multiplier 520 is illustrated in FIG. 5 any number and/or variety of multipliers 520 could be utilized.

In the illustrated example of FIG. 5, as each current sample 505 is received, the example multiplier 520 multiplies the sign bit of the current sample 505 with sign bits of corresponding samples from the sample store 510. For example, if the current sample 505 is the first sample of a set of samples corresponding to a repetition of a short training symbol and/or sequence, then the sign bit of the current sample 505 is multiplied with the sign bit of the first sample of each of the set(s) of samples stored in the example sample store 510. In the example of FIG. 5, the sample store 510 stores six (6) sets of samples and, thus, the sign bit of the current sample 505 is multiplied with the sign bit of the respective bits of each of the six (6) previously stored samples 510.

To sum (i.e., add together) outputs of the example multiplier 520 to compute the correlation output 452, the example correlator 450 of FIG. 5 includes an accumulator 525. At the start of each set of samples (e.g., at the start of each boundary of a received short training symbol and/or sequence), the example accumulator 525 of FIG. 5 resets its current correlation sum to zero. Then, as each output of the example multiplier 520 is received by the accumulator 525, the example accumulator 525 adds the received multiplier output to the current sum. Since each received sample 505 is multiplied by the example multiplier 520 with more than one previously received sample 510, the example accumulator performs multiple additions for each received sample 505 (i.e., one addition for each stored sample set). The larger the correlation sum becomes, the more correlation there is between the current set of samples (e.g., samples of a current short training symbol and/or sequence) and a previous one of the sample sets (e.g., from a previous short training symbol and/or sequence) and, thus, the larger the sum becomes the larger the likelihood that repetitions of a short training sequence 315 of a PLCP frame are being received. At the end of each set of samples (e.g., short training symbol and/or sequence boundary), the current correlation sum is provided to the example decision logic 440 of FIG. 4. The correlation sum is then reset at the start of the next set of samples.

In the illustrated example of FIG. 5, the sets of samples are substantially synchronized (i.e., aligned with) short training symbols and/or sequences and, thus, are substantially synchronized in time with repetitions of the short training sequence 310 (e.g., the short training symbol and/or sequence 311). However, since the short training sequence 310 of FIG. 3 includes repetitions of a single short training symbol and/or sequence, it is periodic and, thus, the sets of samples utilized by the example accumulator 450 need not be time aligned with repetitions of the short training sequence 310.

FIG. 6 illustrates an alternative manner of implementing the example bandwidth detector of FIGS. 2 and/or 4. To detect the start of a frame on the secondary channel of a 40 MHz transmission, the example bandwidth detector 212 of FIG. 6 includes the example BPF 445 and the example correlator 450 of FIG. 4. The operation of the example packet detector 435, the example BPF 445 and the example correlator 450 are identical to those discussed above in connection with FIGS. 4 and/or 5 and, thus, the description of the example BPF 445 and the example correlator 450 will not be repeated here. Instead, the interested reader is referred back to the corresponding descriptions of FIGS. 4 and 5.

To detect the start of a frame on the secondary channel of a 40 MHz transmission and/or the start of a frame of a 20 MHz transmission, the example bandwidth detector 212 of FIG. 6 includes a BPF 605 and a correlator 610. The example BPF 605 of FIG. 6 has a center frequency and bandwidth configured and/or adjustable to substantially pass the primary channel of a 40 MHz transmission and/or a 20 MHz transmission while sufficiently attenuating other signals that may be received by the antenna 205 (e.g., the secondary channel of a 40 MHz transmission, out-of-band noise, etc.).

Implementation and/or operation of the example correlator 610 of FIG. 6 is substantially identical that of the example correlator 450 and, thus, the interested reader is referred back to the description(s) of the example correlator 450 presented above in connection with FIGS. 4 and/or 5.

To decide if a received transmission is 20 MHz or 40 MHz, the example bandwidth detector 212 of FIG. 6 includes decision logic 615. The example decision logic 615 of FIG. 6 makes a bandwidth determination based upon a) a correlation output value 612 provided by the example correlator 610 and/or b) a correlation output value 452 provided by the example correlator 450. If the absolute value of the correlation output 612 does not exceed a threshold, the example decision logic 440 determines that neither a 20 MHz nor a 40 MHz transmission was detected. If the absolute value of the correlation output 612 does exceed the threshold, then the example decision logic 615 of FIG. 6 determines that either a 20 MHz or a 40 MHz transmission was detected and/or started. If both the absolute value of the correlation output 452 and the absolute value of the correlation sum 612 are greater than the same or different threshold(s), the example decision logic 615 of FIG. 6 determines that a 40 MHz transmission was detected and/or has started. If the absolute value of the correlation output value 452 does not exceed the threshold and if the absolute value of the correlation output value 612 exceeds the same or different threshold, the example decision logic 615 determines that a 20 MHz transmission was detected and/or has started.

Like the example decision logic 440 discussed above in connection with FIG. 4, having determined that a 20 MHz or 40 MHz transmission was detected and/or has started, the example decision logic 615 of FIG. 6 may correspondingly configure the example carrier generator 412, the example LPF 415 and/or the example processing circuits 425, 430 of FIG. 4 for receiving and/or processing of the detected signal bandwidth. Which of the example carrier generator 412, the example LPF 415 and/or the example processing circuits 425, 430 need to be configured based upon the mode of the wireless modem 210 (e.g., 20 MHz reception, 40 MHz reception, 20/40 MHz detection, etc.) depends upon an implementation and/or capabilities of the wireless modem 210.

While example bandwidth detectors 212 and a portion of an example wireless modem 210 related to the example bandwidth detectors 212 have been illustrated in FIGS. 4-6, the elements, modules, logic, memory and/or devices illustrated in FIGS. 4, 5 and/or 6 may be combined, re-arranged, eliminated and/or implemented in any of a variety of ways. For example, the example processing circuits 425, 430 may be implemented by a single processing circuit 425, 430 configurable by, for example, the decision logic 440 or 615 to receive transmissions of different bandwidths. Further, the example carrier generator 412, the example LPF 415, the example processing circuits 425, 430, the example bandwidth detector 212, the example packet detector 435, the example decision logic 440, the example BPF 445, the example correlator 450, the example BPF 605, the example correlator 610, the example decision logic 615 and/or, more generally, the example wireless modem 210 of FIGS. 4, 5 and/or 6 may be implemented by hardware, software, firmware and/or any combination of hardware, software and/or firmware. For example, the example processing circuits 425, 430, the example bandwidth detector 212, the example packet detector 435, the example decision logic 440, the example BPF 445, the example correlator 450, the example BPF 605, the example correlator 610, and/or the example decision logic 615 may be implemented via machine accessible instructions executed by any variety of processor such as, for example, a processor from the TI® family of DSPs, processors and/or microcontrollers (e.g., the example processor 905 of FIG. 9). Moreover, a wireless modem 212 may include additional elements, modules, logic, memory and/or devices than those shown in FIGS. 4, 5 and/or 6 and/or may include more than one of any of the illustrated elements, modules and/or devices. For example, persons of ordinary skill in the art will readily appreciate that the example wireless modem 212 of FIG. 4 typically includes a 20 MHz and/or 40 MHz transmitter, a digital-to-analog converter (DAC), etc. that facilitate the transmission of WLAN signals.

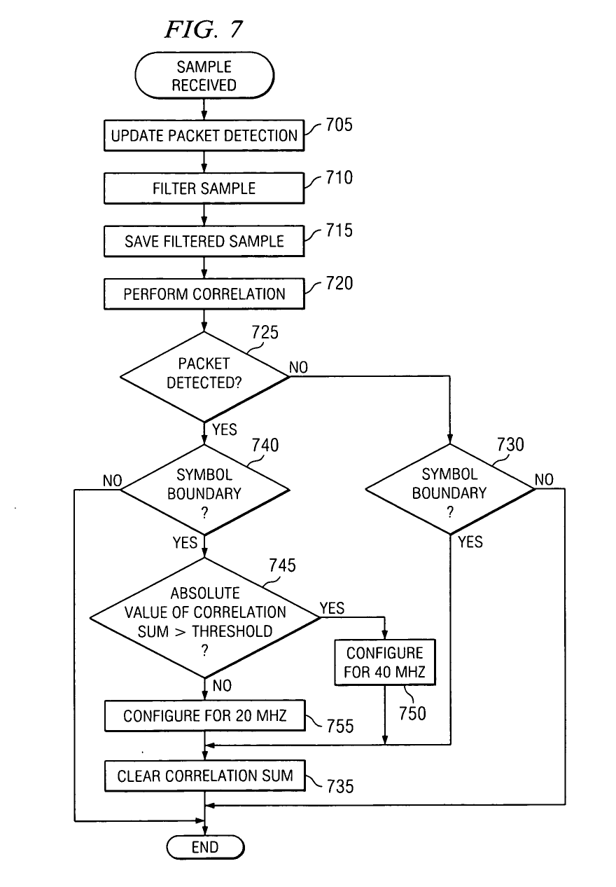

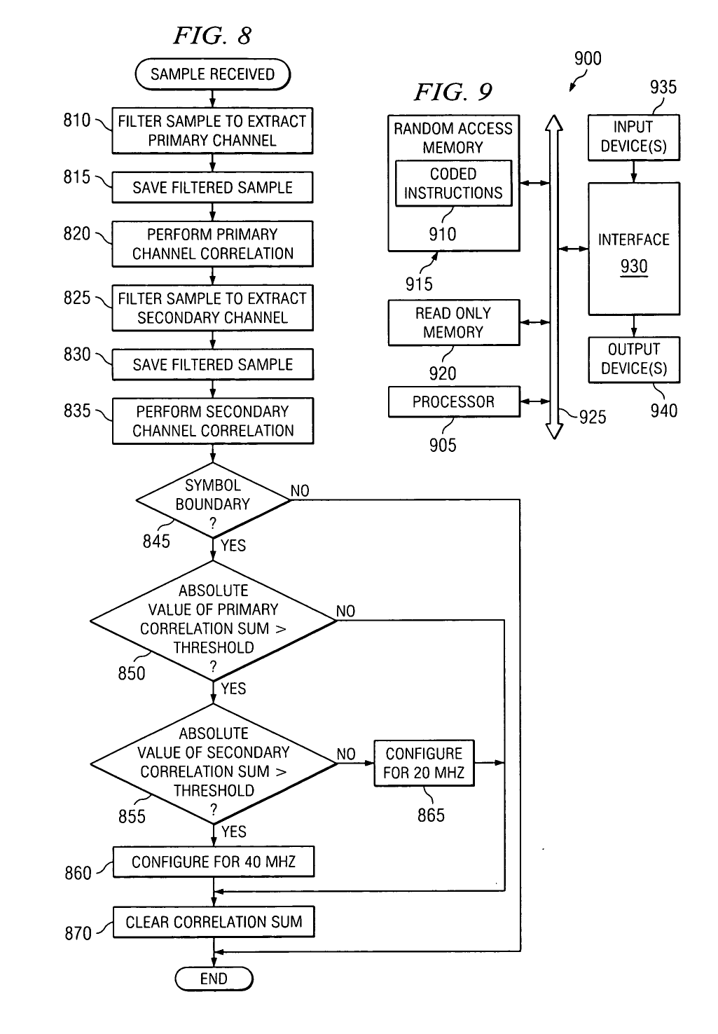

FIGS. 7 and 8 are flowcharts representative of example machine accessible instructions that may be executed to implement the example wireless modem 212, the example bandwidth detector 212, the example decision logic 440, the example BPF 445, the example correlator 450, the example BPF 605, the example correlator 610, and/or, the example decision logic 615 of FIGS. 4, 5 and/or 6 to detect a transmission signal bandwidth. The example machine accessible instructions of FIGS. 7-8 may be executed by a processor, a controller and/or any other suitable processing device. For example, the example machine accessible instructions of FIGS. 7 and/or 8 may be embodied in coded instructions stored on a tangible medium such as a flash memory, or RAM associated with a processor (e.g., the example processor 905 discussed below in connection with FIG. 9). Alternatively, some or all of the example flowcharts of FIGS. 7 and/or 8 may be implemented using an ASIC, a PLD, a FPLD, discrete logic, hardware, firmware, etc. Also, some or all of the example flowcharts of FIGS. 7 and/or 8 may be implemented manually or as combinations of any of the foregoing techniques, for example, a combination of firmware and/or software and hardware. Further, although the example machine accessible instructions of FIGS. 7 and 8 are described with reference to the flowcharts of FIGS. 7 and 8, persons of ordinary skill in the art will readily appreciate that many other methods of implementing the example wireless modem 212, example bandwidth detector 212, the example decision logic 440, the example BPF 445, the example correlator 450, the example BPF 605, the example correlator 610, and/or, the example decision logic 615 of FIGS. 4, 5 and/or 7 to detect a transmission signal bandwidth may be employed. For example, the order of execution of the blocks may be changed, and/or some of the blocks described may be changed, eliminated, sub-divided, or combined. Additionally, persons of ordinary skill in the art will appreciate that the example machine accessible instructions of FIGS. 7 and/or 8 may be carried out sequentially and/or carried out in parallel by, for example, separate processing thread(s), processor(s), device(s), circuit(s), etc.

The example machine accessible instructions of FIG. 7 begin when a bandwidth detector (e.g., the example bandwidth detector 212 of FIGS. 4, 5 and/or 6) receives a sample from, for example, the example ADC 420 of FIG. 4. The bandwidth detector updates the state of its packet detection (e.g., by executing the example packet detector 435 of FIG. 4) based on the received sample (block 705). Using, for example, the example BPF 445 of FIG. 4, the bandwidth detector processes (i.e., filters) the received sample to keep only the portion of a received signal related to the secondary channel of a 40 MHz (block 710). The filtered sample is then saved in, for example, the sample store 510 of FIG. 5 (block 715). The bandwidth detector (e.g., the example correlator 450 of FIG. 4) then correlates the filtered sample with respective ones of past filtered samples stored in the sample store 510 to update the correlation sum (block 720).

If a packet has not been detected by a packet detector (e.g., the example packet detector 435 of FIG. 4) (block 725), the bandwidth detector determines if a short training symbol and/or sequence boundary has been reached (e.g., a new set of 64 samples collected) (block 730). If a short training symbol and/or sequence boundary has been reached (block 730), the bandwidth detector resets the correlation sum to zero (block 735). Control then exits from the example machine accessible instructions of FIG. 7. If a short training symbol and/or sequence boundary has not been reached (block 730), control exits from the example machine accessible instructions of FIG. 7 without resetting the correlation sum (block 735)

Returning to block 725, if a packet is detected (block 725), the bandwidth detector determines if a short training symbol and/or sequence boundary has been reached (e.g., a new set of 64 samples collected) (block 740). If a short training symbol and/or sequence boundary has not been reached (block 740), control exits from the example machine accessible instructions of FIG. 7. If a short training symbol and/or sequence boundary has been reached (block 740), the bandwidth detector (e.g., the example decision logic 440 of FIG. 4) determines if the absolute value of the correlation sum is greater than a threshold (block 745). If the absolute value of the correlation sum is greater than the threshold (block 745), the bandwidth detector configures the wireless modem for 40 MHz operation (block 750). The bandwidth detector then resets the correlation sum to zero (block 735) and control exits from the example machine accessible instructions of FIG. 7.

Returning to block 745, if the absolute value of the correlation sum is not greater than the threshold (block 745), the bandwidth detector configures the wireless modem for 20 MHz operation (block 755). The bandwidth detector then resets the correlation sum to zero (block 735) and control exits from the example machine accessible instructions of FIG. 7.

The example machine accessible instructions of FIG. 8 begin when a bandwidth detector (e.g., the example bandwidth detector 212 of FIGS. 4, 5 and/or 6) receives a sample from, for example, the example ADC 420. Using, for example, the example BPF 605 of FIG. 6, the bandwidth detector processes (i.e., filters) the received sample to keep only the portion of a received signal related to a 20 MHZ transmission and/or the primary channel of a 40 MHz transmission (block 810). The filtered sample is then saved in, for example, a sample store 510 of the example correlator 605 (block 815). The bandwidth detector (e.g., the example correlator 610 of FIG. 6) then correlates the filtered sample with respective ones of past filtered samples to update the correlation sum for the primary channel (i.e., primary correlation sum) (block 820).

Using, for example, the example BPF 445 of FIGS. 4 and/or 6, the bandwidth detector processes (i.e., filters) the received sample to keep only the portion of a received signal related to the secondary channel of a 40 MHz transmission (block 825). The filtered sample is then saved in, for example, a sample store 510 of the example correlator 450 (block 830). The bandwidth detector (e.g., the example correlator 450 of FIGS. 4 and/or 6) then correlates the filtered sample with respective ones of past filtered samples to update the correlation sum for the second channel (block 835).

If a short training symbol and/or sequence boundary (e.g., the start/end of a set of 64 samples) has not been reached (block 845), control exits from the example machine readable instructions of FIG. 8 until another sample is received. If a short training symbol and/or sequence boundary has been reached (block 845), the bandwidth detector (e.g., the example decision logic 615 of FIG. 6) determines if the absolute value of the primary correlation sum is greater than a threshold (block 850). If the absolute value of the primary correlation sum is not greater than the threshold (block 850), the bandwidth detector resets the correlation sum to zero (block 870). Control then exits from the example machine accessible instructions of FIG. 8.

If the absolute value of the primary correlation sum is greater than the threshold (i.e., a 20 MHz or 40 MHz transmission detected) (block 850), the bandwidth detector compares the absolute value of the secondary correlation sum with the threshold (block 855). If the absolute value of the secondary correlation sum is greater than the threshold (block 855), the bandwidth detector configures the wireless modem for 40 MHz operation (block 860). The bandwidth detector then resets the correlation sum to zero (block 870) and control exits from the example machine accessible instructions of FIG. 8.

Returning to block 855, if the absolute value of the secondary correlation sum is not greater than the threshold (block 855), the bandwidth detector configures the wireless modem for 20 MHz operation (block 865). The bandwidth detector then resets the correlation sum to zero (block 870) and control exits from the example machine accessible instructions of FIG. 8.

FIG. 9 is a schematic diagram of an example processor platform 900 that may be used and/or programmed to implement the example bandwidth detector 212, the example decision logic 440, the example BPF 445, the example correlator 450, the example BPF 605, the example correlator 610, the example decision logic 615 and/or, more generally, the example wireless modem 212 of FIGS. 2, 4, 5 and/or 6. For example, the processor platform 900 can be implemented by one or more general purpose processors, cores, microcontrollers, etc. Alternatively, the example processor 225 and/or, more generally, the example processor platform of FIG. 2 may be used to implement the example bandwidth detector 212, the example decision logic 440, the example BPF 445, the example correlator 450, the example BPF 605, the example correlator 610, the example decision logic 615 and/or, more generally, the example wireless modem 212 of FIGS. 2, 4, 5 and/or 6.

The processor platform 900 of the example of FIG. 9 includes a general purpose programmable processor 905. The processor 905 executes coded instructions 910 present in main memory of the processor 905 (e.g., within a RAM 915). The processor 905 may be any type of processing unit, such as a processor from the TI® family of DSPs, cores, processors and/or microcontrollers. The processor 905 may execute, among other things, the example machine accessible instructions of FIGS. 7 and/or 8 to perform transmission signal bandwidth detection. The processor 905 is in communication with the main memory (including a ROM 920 and the RAM 915) via a bus 925. The RAM 915 may be implemented by DRAM, SDRAM, and/or any other type of RAM device, and ROM may be implemented by flash memory and/or any other desired type of memory device. Access to the memory. 915 and 920 maybe controlled by a memory controller (not shown). The RAM 915 may be used to store, for example, the sample store 510 of FIG. 5.

The processor platform 900 also includes an interface circuit 930. The interface circuit 930 may be implemented by any type of interface standard, such as an external memory interface, serial port, general purpose input/output, etc.

One or more input devices 935 and one or more output devices 940 are connected to the interface circuit 930. The input devices 935 may be used to, for example, receive samples from the example ADC 420 and/or to implement the example ADC 420 of FIG. 4.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of comprising:
receiving a first plurality of samples representative of a first signal transmitted on a first wireless local area network (WLAN) channel;
computing a first correlation of a first portion of the first plurality of samples with a second portion of the first plurality of samples;
setting a receiver mode to a first bandwidth if the first correlation exceeds a threshold; and
setting the receiver mode to a second bandwidth if the first correlation is less than the threshold.

2. A method as defined in claim 1, wherein the first WLAN channel is a secondary 20 MHz channel of a 40 MHz channel.

3. A method as defined in claim 1, wherein the first bandwidth is 40 MHz and the second bandwidth is 20 MHz.

4. A method as defined in claim 1, wherein the first signal is a short training sequence, the short training sequence including at least two repetitions of a signal.

5. A method as defined in claim 4, wherein the first portion of the first plurality of samples represents a current one of the at least two repetitions and the second portion of the first plurality of samples represents at least a prior one of the at least two repetitions.

6. A method as defined in claim 1, wherein first correlation is computed using only the signs of the first plurality of samples.

7. A method as defined in claim 1, further comprising:
receiving a second plurality of samples representative of a second signal transmitted on a second WLAN channel; and
computing a second correlation of a first portion of the second plurality of samples with a second portion of the second plurality of samples, wherein setting the receiver mode to the first bandwidth comprises setting the receiver mode to the first bandwidth if the first and the second correlations exceeds the threshold.

8. A method as defined in claim 7, wherein the first WLAN channel is a secondary 20 MHz channel of a 40 MHz channel, the second WLAN channel is a primary 20 MHz channel of the 40 MHz channel, the first bandwidth is 40 MHz, and the second bandwidth is 20 MHz.

9. A method as defined in claim 1, further comprising:
receiving a second plurality of samples representative of a second signal transmitted on a second WLAN channel; and
determining a packet presence based on the second plurality of samples, wherein setting the receiver mode to the second bandwidth comprises setting the receiver mode to the second bandwidth if the first correlation is less than the threshold and if the packet is present.

10. A method as defined in claim 9, wherein the first WLAN channel is a secondary 20 MHz channel of a 40 MHz channel, the second WLAN channel is a primary 20 MHz channel of the 40 MHz channel, the first bandwidth is 40 MHz, and the second bandwidth is 20 MHz.

11. A wireless local area network (WLAN) apparatus comprising:
an analog-to-digital converter to generate a plurality of samples representative of a first signal transmitted on a first WLAN channel; and
a bandwidth detector to compute a first correlation of a first portion of the plurality of samples with a second portion of the plurality of samples, and to set a receiver bandwidth based on the first correlation.

12. A WLAN apparatus as defined in claim 1 1, wherein the bandwidth detector comprises:
a first correlator to compute the first correlation; and
decision logic to set the receiver bandwidth to a first bandwidth if the first correlation exceeds a threshold, and to set the receiver bandwidth to a second bandwidth if the first correlation is less than the threshold.

13. A WLAN apparatus as defined in claim 12, wherein the bandwidth detector further comprises a band-pass filter to filter the plurality of samples.

14. A WLAN apparatus as defined in claim 12, wherein the first correlator comprises:
a sample store to store the second portion of the plurality of samples;
a multiplier to multiply samples of the first portion of the plurality of samples with corresponding ones of the second portion of the plurality of samples; and
an accumulator to sum outputs of the multiplier.

15. A WLAN apparatus as defined in claim 11, wherein the bandwidth detector further comprises:
a first correlator to compute the first correlation;
a packet detector to detect a packet transmitted on a second WLAN channel; and
decision logic to set the receiver bandwidth to a first bandwidth if the first correlation exceeds a threshold, and to set the receiver bandwidth to a second bandwidth if the first correlation is less than the threshold and the packet is detected.

16. A WLAN apparatus as defined in claim 11, wherein the bandwidth detector further comprises:
a first correlator to compute the first correlation;
a second correlator to compute a second correlation based upon a second signal transmitted on a second WLAN channel; and
decision logic to set the receiver bandwidth to the first bandwidth if the first and the second correlations exceed a threshold.

17. A WLAN apparatus as defined in claim 11, wherein the plurality of samples represent signs of the first signal transmitted on the first WLAN channel.

18. An article of manufacture storing machine accessible instructions which, when executed, cause a machine to:
receive a first plurality of samples representative of a first signal transmitted on a first wireless local area network (WLAN) channel;
compute a first correlation of a first portion of the first plurality of samples with a second portion of the first plurality of samples;
set a receiver mode to a first bandwidth if the first correlation exceeds a threshold; and
set the receiver mode to a second bandwidth if the first correlation is less than the threshold.

19. An article of manufacture as defined in claim 18, wherein the machine accessible instructions, when executed, cause the machine to compute the first correlation using only the signs of the first plurality of samples.

20. An article of manufacture as defined in claim 18, wherein the machine accessible instructions, when executed, cause the machine to:
receive a second plurality of samples representative of a second signal transmitted on a second WLAN channel; and
compute a second correlation of a first portion of the second plurality of samples with a second portion of the second plurality of samples, wherein setting the receiver mode to the first bandwidth comprises setting the receiver mode to the first bandwidth if the first and the second correlations exceeds the threshold.

21. An article of manufacture as defined in claim 18, wherein the machine accessible instructions, when executed, cause the machine to:
receive a second plurality of samples representative of a second signal transmitted on a second WLAN channel; and
determine a packet presence based on the second plurality of samples, wherein setting the receiver mode to the second bandwidth comprises setting the receiver mode to the second bandwidth if the first correlation is less than the threshold and if the packet is present.
